(19) United States
(12) Patent Application Publication
(10) Pub. No.: US 2026/0302258 A1
(43) Pub. Date: Oct. 1, 2026

(54) ANODE, ALL-SOLID-STATE BATTERY COMPRISING THE SAME, AND METHOD FOR MANUFACTURING THE SAME

(71) Applicants: Hyundai Motor Company, Seoul (KR); Kia Corporation, Seoul (KR); Foundation of Soongsil University-Industry Cooperation, Seoul (KR)

(72) Inventors: Ji Young Kim, Hwaseong (KR); Ki Yoon Bae, Hwaseong (KR); Ji Hoon Ahn, Seoul (KR); Nilufer Cakmakci Lee, Seoul (KR); Jo Moon, Seoul (KR); Young Jin Jeong, Seoul (KR); Ho Sin Lee, Seoul (KR)

(21) Appl. No.: 19/291,332

(22) Filed: Aug. 5, 2025

(30) Foreign Application Priority Data
Mar. 26, 2025 (KR) 10-2025-0038960

(51) Int. Cl. H01M 4/66; H01M 4/02; H01M 4/82

(52) U.S. Cl. CPC H01M 4/666; H01M 4/661; H01M 4/663; H01M 4/667; H01M 4/82; H01M 2004/021; H01M 2004/027

(57) ABSTRACT

The present disclosure relates to an anode comprising: an anode current collector; and a sheet layer disposed on the anode current collector and including a carbon nanotube sheet and metal particles, wherein the carbon nanotube sheet includes carbon nanotube strands having an average length of 1 m or more and 100 m or less. The present disclosure also relates to a method of manufacturing the anode. In the method, the carbon-nanotube sheet is immersed in an aqueous surfactant solution, for example, 0.001-0.1 M cetyltrimethylammonium bromide, vacuum-dried and then immersed in a silver-nanoparticle colloid solution (0.001-1/0M) that optionally contains a reducing agent such as sodium borohydride, followed by a second vacuum-drying step. The resulting anode exhibits improved electrical conductivity, uniform metal-particle distribution, high coulombic efficiency, and extended cycle life.

### CROSS-REFERENCE TO RELATED APPLICATION

This application claims under 35 U.S.C. § 119(a) the benefit of priority to Korean Patent Application No. 10-2025-0038960, filed in the Korean Intellectual Property Office on Mar. 26, 2025, the entire contents of which are incorporated herein by reference.

### TECHNICAL FIELD

The present disclosure relates to an anode improved in cycle life and efficiency characteristics, an all-solid-state battery including the same, and a method for manufacturing an anode.

### BACKGROUND

Recently, secondary batteries have been widely adopted in diverse fields such as electric vehicles and portable electronic devices. In particular, the all-solid-stage battery has been actively developed to achieve a higher energy density.

Such an anodeless all-solid-stage battery has been developed while focusing on the improvement in stability by substituting an existing liquid electrolyte with a solid electrolyte, and on the performance improvement in energy density and cycle life of the all-solid-stage battery.

However, several technical problems remain before an anodeless all-solid-state battery can be realized. Representatively, a dendrite may be formed in the process of irregularly depositing and stripping the lithium metal. This phenomenon increases the risk of the short circuit caused in the battery, thereby significantly decreasing the stability and the cycle life of the battery together with the loss of the lithium metal and the interface instability.

A conventional technology tries to improve uniformity of the lithium metal deposition through the surface treatment of the current collector or to reduce an interfacial resistance with the solid electrolyte. However, such a manner has a limitation in that the manufacturing process is complex or additional costs are required. In addition, a scheme of employing a higher conductive material, such as a carbon nanotube, as a current collector has been reviewed. However, the powder-type carbon nanotube mainly used may exhibit insufficient electrical connectivity in an electrode.

Accordingly, the commercialization of an anodeless all-solid-state battery requires a new technology that promotes uniform deposition of the lithium metal, secures interface stability, and enhances the stability and the cycle life of the all-solid-state battery.

### SUMMARY

The present disclosure has been made to solve the above-mentioned problems occurring in the existing technologies while advantages achieved by the existing technologies are maintained intact.

Some embodiments according to the present disclosure provide an anode, which has a higher ion conductivity to exhibit higher efficiency, is capable of maintaining the uniform deposition/stripping of the lithium ions to exhibit an excellent cycle life characteristic, an all-solid-state battery including the same, and a method for manufacturing the anode.

The technical problems to be solved by the present disclosure are not limited to the aforementioned problems, and any other technical problems not mentioned herein will be clearly understood from the following description by those skilled in the art to which the present disclosure pertains.

According to some embodiments according to the present disclosure,

More specifically, (1) the present disclosure provides an anode including an anode current collector, and a sheet layer disposed on the anode current collector and including a carbon nanotube sheet and a metal particle, in which the carbon nanotube sheet includes a carbon nanotube strand suitably having an average length ranging from 1 m to 100 m.

(2) The present disclosure provides an anode, in which the sheet layer suitably includes 0.1 wt % of a binder, based on a total weight of the sheet layer, in (1).

(3) The present disclosure provides an anode, in which the carbon nanotube strand suitably has an I_{G}/I_{D} value ranging from 3 to 10, in any one of (1) or (2).

(4) The present disclosure provides an anode, in which the carbon nanotube strand suitably has electrical conductivity ranging from 1.0×10⁵ S·m⁻¹ to 1.0·10⁶ S·m⁻¹, in any one of (1) to (3).

(5) The present disclosure provides an anode, in which the metal particle include at least one selected from the group consisting of silver (Ag), lithium (Li), indium (In), gold (Au), bismuth (Bi), zinc (Zn), aluminum (Al), iron (Fe), tin (Sn), and titanium (Ti), in any one of (1) to (4).

(6) The present disclosure provides an anode, in which the metal particle has an average diameter suitably ranging from 20 nm to 50 nm, in any one of (1) to (5).

(7) The present disclosure provides an anode, in which the metal particle includes silver (Ag), in any one of (1) to (6).

(8) The present disclosure provides an all-solid-state battery including an anode in any one of (1) to (7), a solid electrolyte, and a cathode.

(9) The present disclosure provides a method for manufacturing an anode, which includes fabricating a carbon nanotube sheet, doping a metal particle into the carbon nanotube sheet, and depositing the carbon nanotube sheet doped with the metal particle, on an anode current collector, in which the carbon nanotube sheet includes a carbon nanotube strand having an average length ranging from 1 m to 100 m.

(10) The present disclosure provides a method for manufacturing an anode, further including immersing the carbon nanotube sheet in a surfactant before the doping, in (9).

(11) The present disclosure provides a method for manufacturing an anode, in which the immersing is suitably performed for a time ranging from 10 minutes to 3 hours, in (10).

(12) The present disclosure provides a method for manufacturing an anode, in which the doping is performed by immersing the carbon nanotube sheet into a metal particle colloid solution, in (9).

(13) The present disclosure provides a method for manufacturing an anode, in which the metal particle colloid solution has a concentration suitably ranging from 0.001 M to 1.0 M, in (12).

(14) The present disclosure provides a method for manufacturing an anode, in which the metal particle colloid solution includes a mixture of a metal particle solution and a reducing agent solution, in any one of (12) or (13).

(15) The present disclosure provides a method for manufacturing an anode, further including drying the carbon nanotube sheet after the doping, in (9).

(16) The present disclosure provides a method for manufacturing an anode, further including drying the carbon nanotube sheet after the immersing, in (10).

(17) The present disclosure provides a method for manufacturing an anode, wherein the drying is performed for a time ranging from 12 hours to 36 hours, in any one of (13) or (14).

According some embodiments of the present disclosure, a method for manufacturing an anode, the method comprising: immersing a sheet-type carbon nanotube in an aqueous surfactant solution comprising about 0.001M to 0.1M cetyltrimethylammonium bromide (CTAB) for a time ranging from about 10 minutes to 3 hours; vacuum-drying the surfactant-treated carbon nanotube sheet for about 12 hours to 36 hours; immersing the dried carbon nanotube sheet in a colloid solution comprising silver nanoparticles, silver nitrate (AgNO3) and sodium borohydride (NaBH4), the colloid solution having a concentration of about 0.001 M to 1.0M, for a time ranging from 10 minutes to 24 hours; and vacuum-drying the silver-nanoparticle-doped carbon nanotube sheet for about 12 hours to 356 hours to obtain the anode.

The colloid solution may further comprise trisodium citrate or triethyl citrate as a reducing agent.

The surfactant solution may further comprise octyltrimethylammonium bromide (OTAB).

As discussed, the method and system suitably include use of a controller or processer.

In some embodiments, vehicles are provided that comprise an apparatus as disclosed herein.

### BRIEF DESCRIPTION OF THE DRAWINGS

The above and other objects, features and advantages according to the present disclosure will be more apparent from the following detailed description taken in conjunction with the accompanying drawings

FIGS. 1A and 2A are images obtained by capturing an SEM image immediately after pressing an anode according to some embodiments of the present disclosure and comparative example 1;

FIGS. 1B and 2B are images obtained by capturing an SEM image in an SOC 100 state of an anode according to some embodiments of the present disclosure and comparative example 1;

FIGS. 1C and 2C are images obtained by capturing an SEM image in an DOD 100 state of an anode according to some embodiments of the present disclosure and comparative example 1;

FIG. 3A is a graph illustrating a voltage-capacity curve, a capacity retention rate, and the change in coulombic efficiency, as a cycle progresses in a half-cell employing an anode manufactured according to some embodiments of the present disclosure;

FIG. 3B is a graph illustrating a voltage-capacity curve, a capacity retention rate, and the change in coulombic efficiency, as a cycle progresses in a half-cell employing an anode manufactured according to Comparative Example 1 of the present disclosure;

FIGS. 3C and 3D are graphs illustrating a voltage-capacity curve as a cycle progresses in a half-cell employing an anode manufactured according to Comparative Examples 2 and 3 according to the present disclosure; and

FIG. 3E is a graph illustrating a voltage-capacity curve as a cycle progresses in a half-cell employing an anode manufactured according to Comparative Examples 2 and 3 according to the present disclosure.

### DETAILED DESCRIPTION

Hereinafter, the present disclosure will be described in more detail.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “I_{G}/I_{D} value” herein refers to the ratio of the G-band to D-band intensities in the Raman spectrum of a carbon-based material, used as an index of defect density in carbon nanotubes.

The term “all-solid-state battery” herein refers to an electrochemical cell in which ion transport is provided principally by one or more solid ion-conductive layers, such that the battery operates without a bulk liquid electrolyte phase between the anode and the cathode. Minor interfacial liquids, gels, or polymeric additives that do not form a continuous liquid electrolyte phase are not excluded.

Terms or words used in the present specification and the claims should not be interpreted as commonly-used dictionary meanings but be interpreted as to be relevant to the technical scope according to the present disclosure based on the fact that the inventor may properly define the concept of the terms to explain the disclosure in best ways.

### Anode

The present disclosure provides an anode including an anode current collector, and a sheet layer disposed on the anode current collector and including a carbon nanotube sheet and a metal particle, in which the carbon nanotube sheet includes a carbon nanotube strand having an average length ranging from 1 m to 100 m.

Hereinafter, the configuration of the anode according to the present disclosure will be described in more detail.

The anode current collector according to the present disclosure may collect a current such that electrons move to an external circuit of a battery (all-solid-state battery) and may provide higher electrical conductivity such that electrons rapidly move. The anode current collector may include various materials without a particular limitation, as long as the materials have conductivity without causing a chemical change in the battery. Preferably, the anode current collector may include at least one selected from the group consisting of copper, stainless steel, aluminum, nickel, titanium, sintered carbon, a material obtained by performing surface-treatment for the surface of copper or stainless steel with carbon, nickel, titanium, or silver, and an aluminum-cadmium alloy.

A conventional powder-type carbon nanotube employed to enhance ion conductivity of an electrode requires the use of a binder, which reduces the ion conductivity of the battery. However, the carbon nanotube sheet employed according to the present disclosure includes several long carbon nanotube strands to continuously maintain an ion migration path without the use of a binder or a solvent. In addition, the carbon nanotube sheet exhibits higher crystallinity, thereby resulting in fewer side reactions and improved electrode efficiency.

Accordingly, the carbon nanotube sheet used in the present disclosure exhibits a porous structure in which a bundle is formed by the entanglement of long strands, each comprising multiple single carbon nanotubes. Therefore, the anode according to the present disclosure may include a sheet layer comprising the carbon nanotube sheet and a metal particles which is disposed on the anode current collector.

The average length of the carbon nanotubes included in the carbon nanotube sheet may be at least 1 m, at least 1.5 m, at least 2 m, at least 2.5 m, at least 3 m, at least 3.5 m, at least 4 m, at least 4.5 m, at least 5 m, at least 5.5 m, at least 6 m, at least 6.5 m, at least 7 m, at least 7.5 m, at least 8 m, at least 8.5 m, at least 9 m, at least 9.5 m, or at least 10 m, and may be at most 100 m, at most 90 m, at most 80 m, at most 70 m, at most 60 m, at most 50 m, at most 40 m, at most 30 m, or at most 20 m. Within this range, the ion migration path may be continuously maintained, thereby increasing ion conductivity, ions may be uniformly distributed, thereby suppressing dendrite growth, such that cycle life and capacity retention may be improved.

The carbon nanotube sheet layer according to the present disclosure includes a long carbon nanotube strand to minimize the binder content. Specifically, the binder may be included in an amount of at most 0.1 wt %, at most 0.08 wt %, at most 0.06 wt %, at most 0.04 wt %, or at most 0.02 wt %, based on the total weight of the sheet layer. Most preferably, the sheet layer may not include the binder.

The I_{G}/I_{D} value of the carbon nanotube strand included in the carbon nanotube sheet layer may be at least 3, at least 3.5, at least 4.0, at least 4.5, or at least 5.0, and may be at most 10, at most 9.5, at most 9.0, at most 8.5, at most 8.0, at most 7.5, or at most 7.0. Within this range, the carbon nanotubes exhibit higher crystallinity, thereby enhancing electrical conductivity, improving mechanical strength and stability, reducing lithium-ion loss, and lowering reactivity with lithium ions, such that battery efficiency is improved.

The electrical conductivity of the carbon nanotube strand may be at least 1.0×10⁵ S·m⁻¹, at least 1.5×10⁵ S·m⁻¹, at least 2.0×10⁵ S·m⁻¹, at least 2.5×10⁵ S·m⁻¹, at least 3.0×10⁵ S·m⁻¹, at least 3.5×10⁵ S·m⁻¹, or at least 4.0×10⁵ S·m⁻¹, and may be at most 1.0×10⁶ S·m⁻¹, at most 9.5×10⁵ S·m⁻¹, at most 9.0×10⁵ S·m⁻¹, at most 8.5×10⁵ S·m⁻¹, at most 8.0×10⁵ S·m⁻¹, at most 7.5×10⁵ S·m⁻¹, at most 7.0×10⁵ S·m⁻¹, at most 6.5×10⁵ S·m⁻¹, or at most 6.0×10⁵ S·m⁻¹. Within this range, the ion migration path of the anode may be continuously maintained, and the current may be uniformly distributed, thereby suppressing side reactions, and enhancing energy efficiency.

The carbon nanotube sheet layer according to the present disclosure may include a metal particle, and the metal particle may be positioned in internal pores of the carbon nanotube sheet to impart a lithium-affinity characteristic to the carbon nanotube sheet, thereby further improving the ion conductivity of the carbon nanotube sheet.

Accordingly, the metal particle should have a lithium-affinitive characteristic to form an alloy with lithium. The metal particle may include at least one selected from the group consisting of silver (Ag), lithium (Li), indium (In), gold (Au), bismuth (Bi), zinc (Zn), aluminum (Al), iron (Fe), tin (Sn), and titanium (Ti). Specifically, the metal particle may be most preferably silver (Ag). In this case, plating/stripping of lithium may be uniformly maintained, thereby effectively suppressing the formation of lithium dendrites, such that the cycle life and Coulombic efficiency of the battery may be improved.

The average diameter of the metal particle may be at least 20 nm, at least 22 nm, at least 23 nm, at least 24 nm, at least 25 nm, at least 26 nm, at least 27 nm, at least 28 nm, at least 29 nm, or 3 at least 0 nm, and may be at most 50 nm, at most 49 nm, at most 48 nm, at most 47 nm, at most 46 nm, at most 45 nm, at most 44 nm, at most 43 nm, at most 42 nm, at most 41 nm, or at most 40 nm. Within this range, the metal particle may be uniformly distributed between the pores of the carbon nanotube sheet layer.

The anode according to the present disclosure may not include an anode active material. Accordingly, during charging, lithium ions are deposited between the carbon nanotube sheet layer and the anode current collector, and during discharging, lithium metal may be stripped and operate. Accordingly, as compared to a conventional anode, the anode according to the present disclosure may be reduced in thickness, thereby achieving high energy density, and significantly reducing the weight of the battery.

### All-Solid-State Battery

The present disclosure may provide an all-solid-state battery (hereinafter, simply a “battery”) including the anode, a cathode, and a solid electrolyte layer.

The cathode and solid electrolyte may include various materials without particular limitation, as long as the materials are employed in general all-solid-state batteries.

### Anode Manufacturing Method

The present disclosure may provide a method for manufacturing the anode includes fabricating a carbon nanotube sheet, doping metal particle into the carbon nanotube sheet, and depositing the carbon nanotube sheet doped with the metal particle onto an anode current collector, in which the carbon nanotube sheet includes carbon nanotube strands having an average length ranging from 1 m to 100 m.

Hereinafter, the method for manufacturing the anode according to the present disclosure will be described in more detail.

The anode manufacturing method may be a method for manufacturing the anode of the present disclosure. Accordingly, the carbon nanotube sheet, the metal particle, and the anode current collector may be applied to the method for manufacturing the anode, as described above.

Specifically, the method for manufacturing the anode may include the step of fabricating the carbon nanotube sheet by continuously synthesizing carbon nanotube strands and winding them with a roller to form a single bundle. The carbon nanotube sheet fabricated through this step may maintain continuous ion pathways, thereby exhibiting excellent ionic conductivity.

The method for manufacturing the anode according to the present disclosure may include the step for immersing the carbon nanotube sheet in a surfactant before doping. Through the present step, positive charges appeared on the surface of the carbon nanotube sheet and makes ionic bonding with the negative charge of a metal colloid such that the metal particle may be strongly attached to the carbon nanotube sheet. Additionally, metal particle doped onto the surface of the carbon nanotube bundle may be prevented from being aggregated, thereby contributing to forming metal particle in a nano scale.

The surfactant may be a cationic surfactant. Specifically, the surfactant may include at least one selected from the group consisting of cetyltrimethylammonium bromide (CTAB), cetyltrimethylammonium chloride (CTAC), dodecyltrimethylammonium bromide (DTAB), dodecyltrimethylammonium chloride (DTAC), benzalkonium chloride (BAC), tetradecyltrimethylammonium bromide (TTAB), and octyltrimethylammonium bromide (OTAB).

The immersing may be performed for at least 10 minutes, at least 20 minutes, at least 30 minutes, at least 40 minutes, at least 50 minutes, or at least 60 minutes, and may be at most 3 hours, at most 170 minutes, at most 160 minutes, at most 150 minutes, at most 140 minutes, at most 130 minutes, or at most 120 minutes. Within this range, metal particle at the nano scale may be formed.

The present disclosure may include the step for drying the carbon nanotube sheet after immersing. According to the present step, the surfactant may be fixed onto the surface of the carbon nanotube sheet, thereby enhancing dispersibility and functionality.

The method for manufacturing the anode according to the present disclosure may include the step for doping metal particle into the carbon nanotube sheet. According to the present step, the metal particle may be doped into the internal pores of the carbon nanotube sheet, thereby fabricating the carbon nanotube sheet doped with the metal particle and allowing the doped metal particle to increase the ion conductivity of the anode.

The doping may be performed by immersing the carbon nanotube sheet in a metal particle colloid solution (or, hereinafter, referred to as the “colloid solution”). The colloid solution may be a mixture of a metal particle solution and a reducing agent solution.

The reducing agent solution may be included in the colloid solution to allow anions to surround the metal particle. Specifically, the reducing agent solution may include at least one selected from the group consisting of a NaBH₄ solution, a Na₃C₆H₅O₇ (trisodium citrate) solution, and a C₁₂H₂₀O₇ (triethyl citrate) solution.

The concentration of the colloid solution may range from at least 0.001 M, at least 0.01 M, at least 0.02, at least 0.03 M, at least 0.04 M, at least 0.05 M, at least 0.06 M, at least 0.07 M, at least 0.08 M, at least 0.09 M, or at least 0.10 M and may be at most 1.0 M, at most 0.95 M, at most 0.90 M, at most 0.85 M, at most 0.80 M, at most 0.75 M, at most 0.70 M, at most 0.65 M, at most 0.60 M, at most 0.55 M, or at most 0.50 M. Within this range, metal nanoparticles in the nanoscale may be appropriately formed.

The process for immersing the carbon nanotube sheet into the colloid solution having the metal particle may be performed for a time of at least 10 minutes, at least 20 minutes, at least 30 minutes, at least 40 minutes, at least 50 minutes, or at least 60 minutes, and at most 2 hours, at most 110 minutes, 100 minutes, at most 90 minutes, or at most 80 minutes. Within this range, the metal nanoparticles may be uniformly doped into the carbon nanotube sheet.

The present disclosure may include a step for drying the carbon nanotube sheet after the doping process. According to the present step, the metal nanoparticles may be fixed within the carbon nanotube sheet.

The drying steps after immersing and after doping may be performed by vacuum drying, and each drying step may be independently performed for a time of at least 12 hours, at least 13 hours, at least 14 hours, at least 15 hours, at least 16 hours, at least 17 hours, at least 18 hours, or at least 20 hours, and at most 36 hours, at most 35 hours, at most 34 hours, at most 33 hours, at most 32 hours, at most 31 hours, at most 30 hours, at most 29 hours, at most 28 hours, at most 2 hours, or at last 26 hours. Within this range, the drying effect may be maximized.

The method for manufacturing an anode according to the present disclosure may include the step for depositing the carbon nanotube sheet, which is doped with metal particle, onto the anode current collector. The step may be performed by depositing each layer and pressing the layers.

Hereinafter, although some embodiments and comparative examples will be described in more detail, the present disclosure is not limited to the embodiment and the comparative examples. Some embodiments of the present disclosure may have various modifications, and the scope of the present disclosure is not limited to following embodiments. The embodiments of the present disclosure are provided to describe the present disclosure more completely for those skilled in the art.

### Embodiment

Carbon nanotubes were synthesized by injecting a carbon precursor solution containing acetone and ethylene glycol, ferrocene serving as a catalyst precursor, and an activator of thiophene serving as an activator, were introduced into a heated vertical synthesis furnace heated at a constant rate, together with hydrogen gas serving as carrier gas. When the synthesis solution was supplied to the heated vertical synthesis furnace, iron was extracted from ferrocene serving as the catalyst precursor and sulfur was extracted from the thiophene serving as the activator by thermal energy to form ferrous sulfide in a liquid phase. In this case, carbons, which were supplied by decomposing the carbon precursor, diffuse into the ferrous sulfide to become saturated and to grow carbon nanotubes. Subsequently, the precursors are continuously injected to form a bundle of carbon nanotubes, and the carbon nanotube strands were wound using rollers to fabricate the carbon nanotube sheet.

The fabricated carbon nanotube sheet was immersed in a cationic surfactant aqueous solution of TAB (Cetyltrimethylammonium bromide; CTAB) for 180 minutes and then dried in a vacuum oven for 24 hours. In addition, separately, a colloid solution having Ag nanoparticles was prepared by mixing aqueous solutions of AgNO₃ and NaBH₄, and the carbon nanotube sheet previously dried was immersed in the colloid solution for 24 hours, and then was dried in a vacuum oven for 24 hours to fabricate a carbon nanotube sheet introduced with Ag nanoparticles.

Subsequently, a sulfide-based solid electrolyte in powder form was prepared into a pellet form, and the carbon nanotube sheet introduced with the AG nanoparticles and Ni metal serving as the metal current collector were sequentially laminated onto the sulfide-based solid electrolyte pellet. Then, specific pressure was applied to the result to manufacture the anode.

### Comparative Example 1

An anode was manufactured in a manner the same as the manner of Embodiment, except for employing the carbon nanotube sheet, which was not immersed in the colloid solution, and thus not introduced with Ag nanoparticles, when compared to Embodiment.

### Comparative Example 2

An anode was manufactured by applying and drying an anode active material slurry, which contains polyvinylidene fluoride (PVDF) serving as a binder and the powder-type carbon nanotubes, onto Ni which is the anode current collector.

### Comparative Example 3

Powder-type carbon nanotubes were immersed in a cationic CTAB solution serving as surfactant and subjected to ultrasonic treatment for 1 hour and then dried in an oven for 24 hours. Subsequently, the powder-type carbon nanotubes dried were immersed in a silver nanoparticle colloid solution for 180 minutes and then dried in an oven for 24 hours.

Thereafter, an anode was manufactured in a manner the same as a manner according to Comparative Example 2, except that the powder-type carbon nanotubes introduced with Ag was utilized instead of the powder-type carbon nanotube according to Comparative Example 2, as compared to Comparative example 2.

### Experimental Example 1 Evaluation for Lithium Deposition Characteristics of Anode

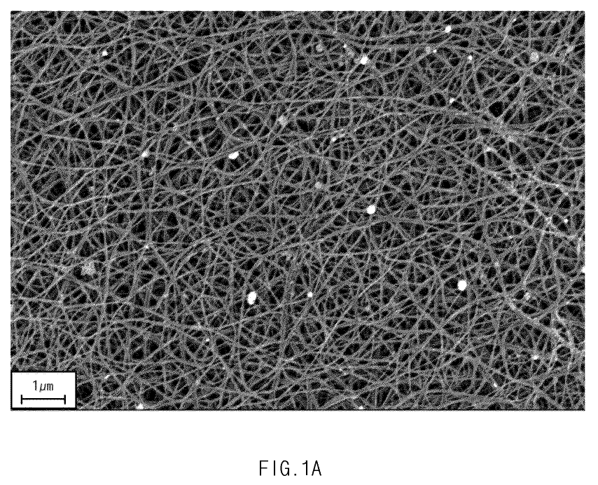

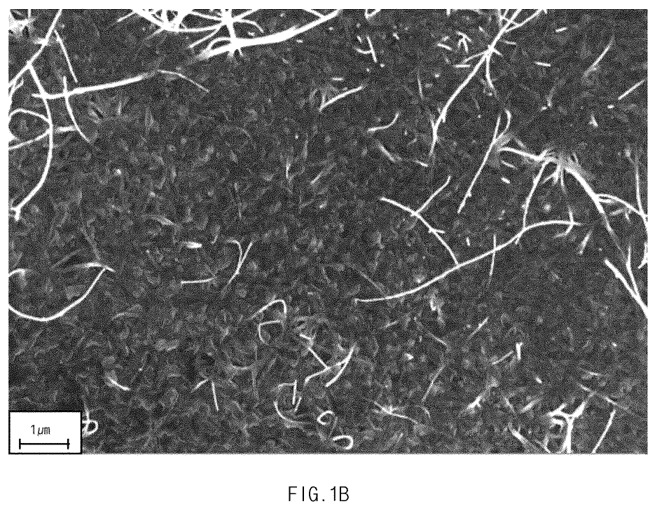

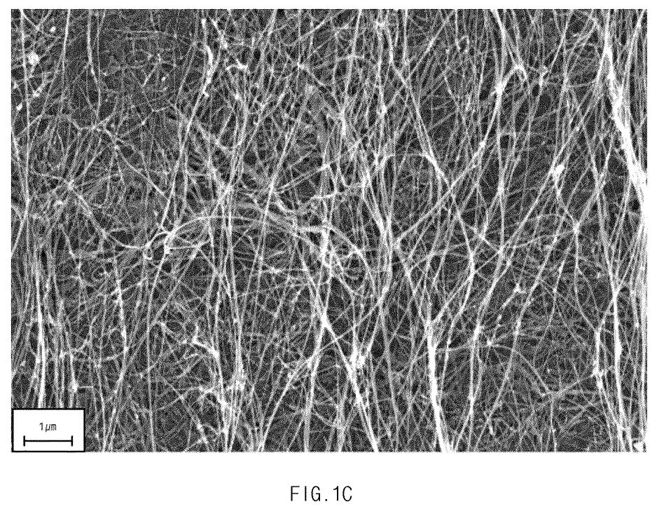

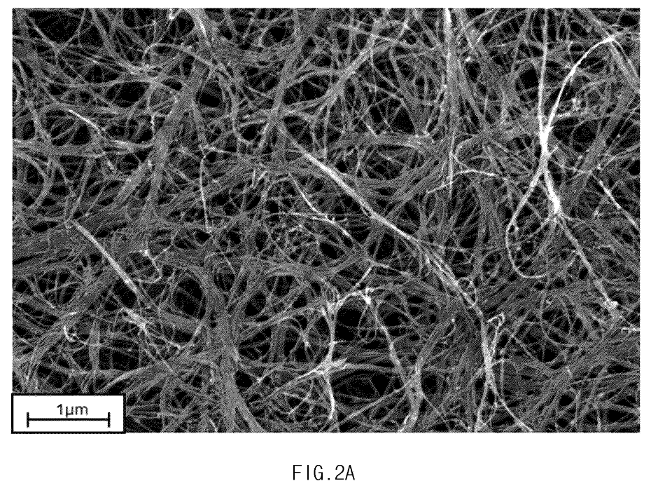

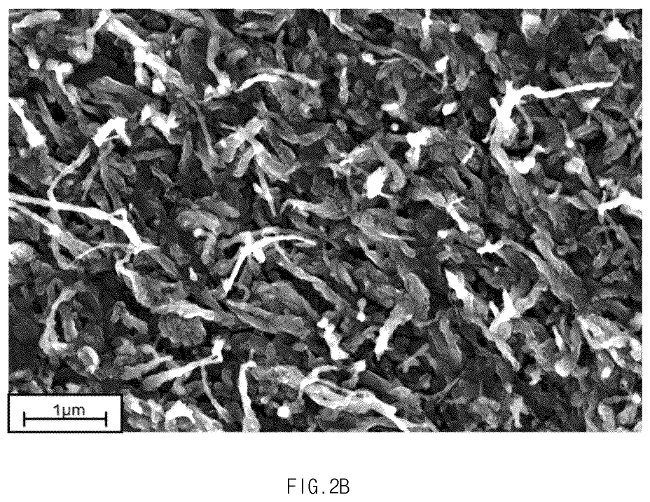

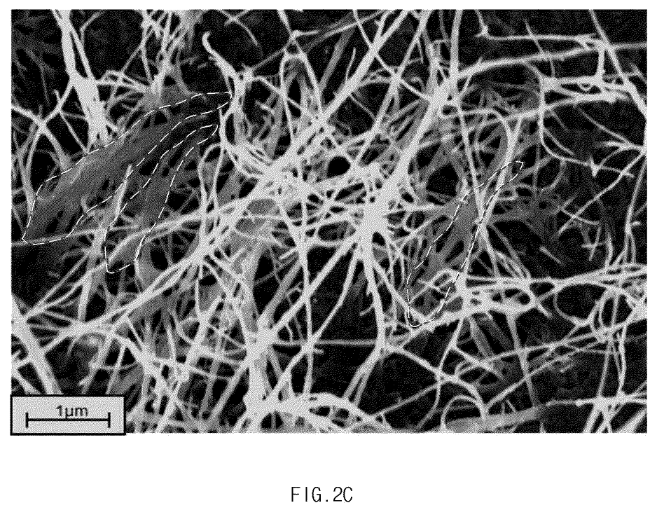

A half-cell configured using the anodes manufactured according to Embodiment and Comparative Example 1, Li₆OS₅Cl (LPSCl), and lithium metal. An anode was photographed through scanning electron microscopy (SEM) to determine the lithium deposition characteristic immediately after the anode is assembled, or after charging/discharging, and the photographed anode is shown in FIG. 1A to 1C, and FIG. 2A to 2C.

Referring to FIGS. 1A and 2A, it was recognized that the porous structure of the carbon nanotube sheet was maintained even after the pressing process when the anode was manufactured. Additionally, referring to FIGS. 1B and 2B, it may be recognized that although the anodes according to Embodiment and Comparative Example 1 had internal pores filled with lithium in an SOC 100 state, the anode including silver particles according to Embodiment shows more uniform deposition than that of the anode according to Comparative Example 1. Similarly, it may be recognized from FIGS. 1C and 2C that the anode according to Comparative Example 1 had remaining lithium in a DOD 100 state, and showed the incomplete stripping of lithium, while the anode according to some embodiments of the present disclosure showed complete lithium stripping, showed a wall surface of the nanotube having no remaining lithium, and showed silver particles stably maintained, in a DOD 100 state.

From the above results, it may be recognized that the anode according to the present disclosure contained silver nanoparticles to improve the electrical conductivity and induced the uniform deposition/stripping of the lithium during charging/discharging.

### Experimental Example 2 Evaluation of Electrochemical Properties of the Anode

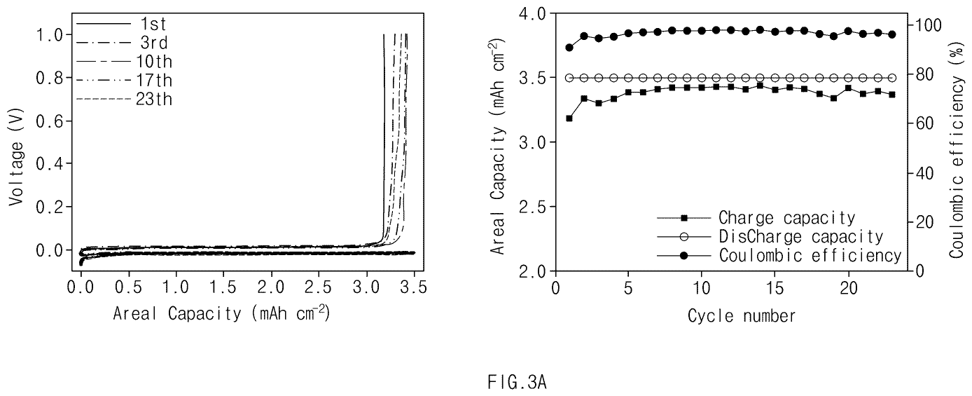

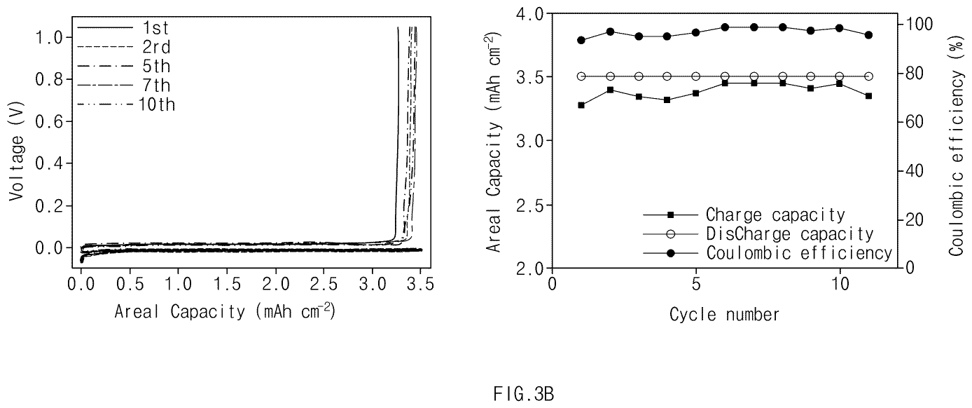

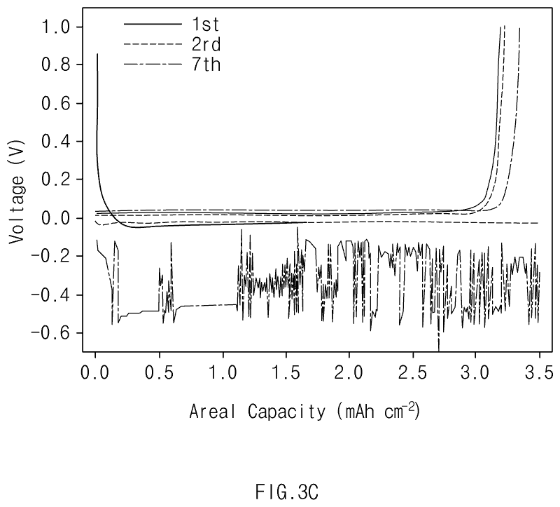

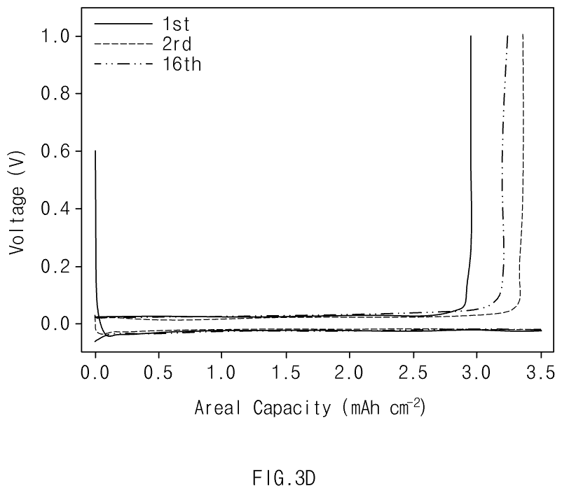

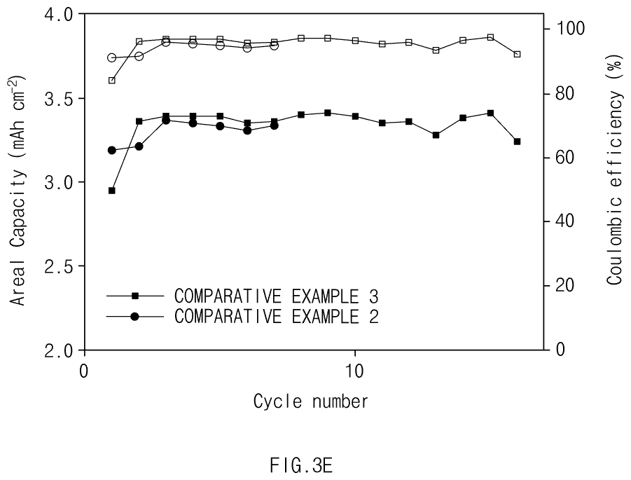

A half-cell was configured using the anodes manufactured in the above-described Example and Comparative Examples, Li₆OS₅Cl (LPSCl), and lithium metal. The electrochemical properties of the anode were evaluated by charging and discharging the anode at a current density of 1.167 mA/cm², with a capacity of 3.5 mAh/cm², and at 30° C. Specifically, charge/discharge curves and capacity retention rates as a function of a cycle number for the half-cells using the anodes of Embodiment and Comparative Examples 1 to 3 described above are plotted as graphs and illustrated in FIGS. 3A to 3E. The cycle life (cycle number), an initial coulombic efficiency (ICE), and average coulombic efficiency (ACE) were measured according to the following measurement manners and summarized in following Table 1.

### [Measurement Manner]

Cycle life (cycle number): the number of times of operating was measured until a point showing the coulombic efficiency of at least 100%.

Initial coulombic efficiency [%]: the ratio of discharge capacity to charge capacity in the first cycle was calculated through following Equation 1.

$$Equation 1$$

$$Initial coulombic efficiency [ \% ] = ( Discharge Capacity / Charge Capacity ) \times 100$$

Average coulombic efficiency: the arithmetic mean value of the coulombic efficiencies from the second cycle until the occurrence of internal short-circuit, was calculated.

TABLE 1

| | | Initial coulombic | Average coulombic |
|---|---|---|---|
| | Cycle | efficiency [%] | efficiency [%] |
| Embodiment 1 | 23 | 91.01 | 96.91 |
| Comparative | 11 | 93.57 | 95.88 |
| Example 1 | | | |
| Comparative | 7 | 91.16 | 96.40 |
| Example 2 | | | |
| Comparative | 16 | 84.30 | 94.27 |
| Example 3 | | | |

Referring to Table 1 an FIG. 3A, it may be recognize that the anode according to e present disclosure exhibited a gradual decrease in capacity during charging/discharging and maintained stable performance despite the progression of cycles, so stable charging/discharging was possible even after 20 cycles. In particular, referring to FIG. 3B, it may be recognized that the anode according to the present disclosure exhibited superior performance in terms of cycle life, long-term efficiency, and stability, as compared to the anode according to Comparative Example 1, having no silver nanoparticles.

In addition, referring to Table 1 and FIGS. 3C to 3E, it may be recognized that the anode according to Comparative Example 3 exhibited a remarkably inferior cycle life, and the anode according to Comparative Example 2 showed improved cycle life characteristics, as compared to the anode according to Comparative Example 3, and however, still exhibited lower cycle characteristics and coulombic efficiency, as compared to the anode according to the present disclosure.

From the above results, it may be recognized that the present disclosure may accelerate lithium diffusion by the doping silver nanoparticles, thereby reducing electrochemical losses caused during the deposition and stripping of lithium metal, such that extended cycle life characteristics and excellent coulombic efficiency are exhibited. In addition, the anode of the present disclosure may employ a sheet-type carbon nanotube. Accordingly, even in the process for manufacturing the anode, caps of the carbon nanotubes may be less damaged as compared to powder-type carbon nanotubes, thereby exhibiting to higher coulombic efficiency, and improved in cycle life characteristic. Accordingly, it may be understood that the anode according to the present disclosure may be improved in the cycle life and efficiency characteristics of an electrode by employing sheet-type carbon nanotubes and doping with silver nanoparticles.

According to the present disclosure, as the anode includes the carbon nanotube sheet, the movement path of electrons may be continuously maintained such that the ion conductivity is improved. In addition, as the anode includes metal particle, the uniform deposition/striping of the lithium ions may be maintained, such that the cycle life characteristics improved. Accordingly, the all-solid-state battery including the anode according to the present disclosure may exhibit the excellent efficiency and the excellent cycle life characteristic.

In addition, according to the method for manufacturing the anode, the metal particle may be uniformly doped in the carbon nanotube sheet. Accordingly, the anode manufactured through the method may exhibit the excellent efficiency and the excellent cycle life characteristics.

Hereinabove, although the present disclosure has been described with reference to exemplary embodiments and the accompanying drawings, the present disclosure is not limited thereto but may be variously modified and altered by those skilled in the art to which the present disclosure pertains without departing from the spirit and scope according to the present disclosure claimed in the following claims.

What is claimed is:

1. An anode comprising:
an anode current collector; and
a sheet layer disposed on the anode current collector, the sheet layer comprising a carbon nanotube sheet and a metal particle,
wherein the carbon nanotube sheet comprises a carbon nanotube strand having an average length ranging from 1 m to 100 m.

2. The anode of claim 1, wherein the sheet layer comprises 0.1 wt % of a binder, based on a total weight of the sheet layer.

3. The anode of claim 1, wherein the carbon nanotube strand has an I_{G}/I_{D} value ranging from about 3 to 10.

4. The anode of claim 1, wherein the carbon nanotube strand has an electrical conductivity ranging from about 1.0×10⁵ S·m⁻¹ to 1.0·10⁶ S·m⁻¹.

5. The anode of claim 1, wherein the metal particle comprise at least one selected from the group consisting of silver (Ag), lithium (Li), indium (In), gold (Au), bismuth (Bi), zinc (Zn), aluminum (Al), iron (Fe), tin (Sn), and titanium (Ti).

6. The anode of claim 1, wherein the metal particle has an average diameter ranging from about 20 nm to 50 nm.

7. The anode of claim 1, wherein the metal particle comprises silver (Ag).

8. An all-solid-state battery comprising the anode of claim 1, a solid electrolyte, and a cathode.

9. A method for manufacturing an anode, the method comprising:
preparing a carbon nanotube sheet;
doping the carbon nanotube sheet with a metal particle; and
depositing the carbon nanotube sheet onto an anode current collector,
wherein the carbon nanotube sheet comprises a carbon nanotube strand having an average length ranging from about 1 m to 100 m.

10. The method of claim 9, further comprising:
immersing the carbon nanotube sheet in a surfactant before the doping.

11. The method of claim 10, wherein the immersing is performed for a time ranging from about 10 minutes to 3 hours.

12. The method of claim 9, wherein the doping is performed by immersing the carbon nanotube sheet into a metal particle colloid solution.

13. The method of claim 12, wherein the metal particle colloid solution has a concentration ranging from about 0.001 M to 1.0 M.

14. The method of claim 12, wherein the metal particle colloid solution comprises a mixture of a metal particle solution and a reducing agent solution.

15. The method of claim 9, further comprising:
drying the carbon nanotube sheet after the doping.

16. The method of claim 10, further comprising:
drying the carbon nanotube sheet after the immersing.

17. The method of claim 13, wherein the drying is performed for a time ranging from about 12 hours to 36 hours.

18. A method for manufacturing an anode, the method comprising:
immersing a sheet-type carbon nanotube in an aqueous surfactant solution comprising about 0.001M to 0.1M cetyltrimethylammonium bromide (CTAB) for a time ranging from about 10 minutes to 3 hours;
vacuum-drying the surfactant-treated carbon nanotube sheet for about 12 hours to 36 hours;
immersing the dried carbon nanotube sheet in a colloid solution comprising silver nanoparticles, silver nitrate (AgNO3) and sodium borohydride (NaBH4), the colloid solution having a concentration of about 0.001 M to 1.0M, for a time ranging from 10 minutes to 24 hours; and
vacuum-drying the silver-nanoparticle-doped carbon nanotube sheet for about 12 hours to 356 hours to obtain the anode.

19. The method of claim 18, wherein the colloid solution further comprises trisodium citrate or triethyl citrate as a reducing agent.

20. The method of claim 18, wherein the surfactant solution further comprises octyltrimethylammonium bromide (OTAB).
